(19) United States
(12) Patent Application Publication
(10) Pub. No.: US 2014/0059000 A1
(43) Pub. Date: Feb. 27, 2014

(54) COMPUTER SYSTEM AND PARALLEL DISTRIBUTED PROCESSING METHOD

(71) Applicant: Masaaki Hosouchi, Tokyo (JP)

(72) Inventor: Masaaki Hosouchi, Tokyo (JP)

(73) Assignee: HITACHI, LTD., Tokyo (JP)

(21) Appl. No.: 14/007,797

(22) PCT Filed: Apr. 8, 2011
(86) PCT No.: PCT/JP2011/058907

§ 371 Date: Sep. 26, 2013

(51) Int. Cl. G06F 17/30

(52) U.S. Cl. CPC G06F 17/30289
USPC 707/609

(57) ABSTRACT

It is provided a computer system comprising a database server, a job execution server and a scheduling server. Each of the servers includes a processor executing a program and a memory storing the program. The database server divides a range of key values included in records stored in a database managed by the database server into a plurality of sections, and obtains distribution information of records in each divided section. The scheduling server holds database server configuration information showing ranges of key values included in records stored in the database, generates a plurality of divided ranges by combining a plurality of sections corresponding to the same range of key values based on the distribution information of records and the database server configuration information, and generates a record acquisition range parameter that shows, for each divided range generated, records in the divided range as records to be acquired.

### BACKGROUND OF THE INVENTION

The present invention relates to a computer system, and in particular to a computer system that executes parallel distributed processing of batch jobs including the input/output to a database.

There are numerous types of techniques known to increase the batch job speed in a computer system that executes batch jobs (batch processes) for processing a large amount of data.

JP 2000-148451 A discloses a method for parallel distributed processing of a job. According to this method, data targeted for processing is divided into a plurality of pieces of divided data in accordance with the amount thereof, a batch job is divided into a plurality of divided jobs, and each divided data is allocated to a corresponding divided job so as to cause the plurality of divided jobs to run simultaneously.

JP 2007-264794 A discloses a method for increasing the job execution speed. According to this method, when executing parallel distributed processing by dividing a job, processing time periods for the divided jobs are equalized by optimally allocating the divided jobs to a group of usable resources.

### SUMMARY OF THE INVENTION

Incidentally, some of the aforementioned batch jobs include the input/output of a large amount of data to a database. For example, such jobs may extract data stored in the database and make the extracted data modified, summarized, and organized into a form. Alternatively, such jobs may check duplication of data to be stored and modify the data before storing the data in the database.

However, the methods disclosed in JP 2000-148451 A and JP 2007-264794 A have some problem in which it is not able to increase the speed of such jobs including the input/output of data to a database sufficiently. This is because contention occurs over access to a DB server which is a computer that inputs/outputs data to a database.

More specifically, in case where job execution servers that execute batch jobs and DB servers are provided such that the relationships therebetween are not fixed and the job execution servers and the DB servers are not equal in number in consideration of countermeasures against failures and of a load ratio between batch jobs and processing for input/output data to the database, contention over access to the DB servers and centralization of processing to a specific DB server occur, thereby reducing a system performance. Furthermore, as input data is input to the database, it is difficult to determine the optimal number of divisions and to balance the pieces of divided data.

One method for preventing contention over access to DB servers is called partitioning whereby DB servers and job execution servers are separated in logical units corresponding to regions, groups of multiple stores, and the like. According to this partitioning method, the DB servers are in fixed one-to-one relationship with the job execution servers; that is to say, the number of the provided DB servers and the number of the provided job execution servers are equal. This prevents a plurality of job execution servers from accessing the same DB server, namely contention over access.

However, in case where failures occur in any of the DB servers or the job execution servers while no auxiliary server is provided, the one-to-one relationship between the DB servers and the job execution servers is lost, and contention over access to a specific DB server occurs. Furthermore, providing an auxiliary server requires a cost therefore. Also, in case where the amount of data varies significantly with each partition, it is difficult to transfer data between partitions, thus increasing a load on a specific job execution server. In addition, in case where a load on batch jobs is not balanced with a load on processing for input/output data to a database, a job execution server or a DB server with a high load acts as a bottleneck. The present invention has been made in view of the above mentioned problems. A main object of the present invention is to provide a computer system and a parallel distributed processing method that can, in parallel distributed processing of jobs that include the input/output to a database, execute jobs at high speed while preventing contention over access to a DB server that inputs/outputs data to the database.

The representative one of inventions disclosed in this application is outlined as follows. There is provided a computer system comprising: one or more database servers that execute processing for input/output records to databases; one or more job execution servers that execute jobs including the input/output processing; and a scheduling server that schedules the jobs executed by the one or more job execution servers. The one or more database servers, the one or more job execution servers and the scheduling server each includes a processor that executes a program and a memory that stores the program executed by the processor. Each of the one or more database server divides a range of key values included in records stored in a database managed by the database server into a plurality of sections, and obtains distribution information of records in each divided section. The scheduling server holds database server configuration information that shows ranges of key values included in records stored in the database managed by the one or more database servers, generates a plurality of divided ranges by combining a plurality of sections corresponding to the same range of key values based on the obtained distribution information of records and the database server configuration information held in the scheduling server, and generates a record acquisition range parameter that shows, for each divided range generated, records in the divided range as records to be acquired.

According to the present invention, in parallel distributed processing of jobs that include the input/output to a database, jobs can be executed at high speed while preventing contention over access to a DB server that inputs/ outputs data to the database.

### BRIEF DESCRIPTION OF THE DRAWINGS

FIG. 1 is a diagram illustrating an example of a hardware configuration of a computer system according to a first embodiment of the present invention.

FIG. 2 is a block diagram illustrating the computer system according to the first embodiment of the present invention.

FIG. 3 is a diagram illustrating an example of DB server configuration information according to the first embodiment of the present invention.

FIG. 4 is a diagram illustrating an example of record distribution information according to the first embodiment of the present invention.

FIG. 5 is a diagram illustrating an example of a record distribution acquisition method instruction parameter according to the first embodiment of the present invention.

FIG. 6 illustrates an example of a record distribution management table according to the first embodiment of the present invention.

FIG. 7 illustrates an example of a divided data management table according to the first embodiment of the present invention.

FIG. 8 is a flowchart of control logic of a record distribution acquisition unit according to the first embodiment of the present invention.

FIG. 9 is a flowchart of control logic of a record acquisition range parameter generation unit according to the first embodiment of the present invention.

FIG. 10 is a flowchart of control logic of a job scheduling unit according to the first embodiment of the present invention.

FIG. 11 is a flowchart of control logic of a job program activation unit according to the first embodiment of the present invention.

FIG. 12 is a flowchart of control logic of a job program unit according to the first embodiment of the present invention.

FIG. 13 is a flowchart of control logic of DB request reception unit according to the first embodiment of the present invention.

FIG. 14 is a flowchart of control logic of the DB access unit according to the first embodiment of the present invention.

FIG. 15 illustrates an example of a hardware configuration of a computer system according to a second embodiment of the present invention.

FIG. 16 is a block diagram illustrating the computer system according to the second embodiment of the present invention.

FIG. 17 illustrates an example of input data according to the second embodiment of the present invention.

FIG. 18 illustrates an example of divided data according to the second embodiment of the present invention.

FIG. 19 is a flowchart of first control logic of a data division unit according to the second embodiment of the present invention.

FIG. 20 is a flowchart of second control logic of the data division unit according to the second embodiment of the present invention.

FIG. 21 is a flowchart of control logic of a job program unit according to the second embodiment of the present invention.

FIG. 22 is a flowchart of control logic of the DB request reception unit according to the second embodiment of the present invention.

FIG. 23 is a flowchart of control logic of a DB access unit according to the second embodiment of the present invention.

### DETAILED DESCRIPTION OF THE PREFERRED EMBODIMENTS

The following describes embodiments of the present invention with reference to the drawings.

### First Embodiment

First, a description is given of the first embodiment of the present invention.

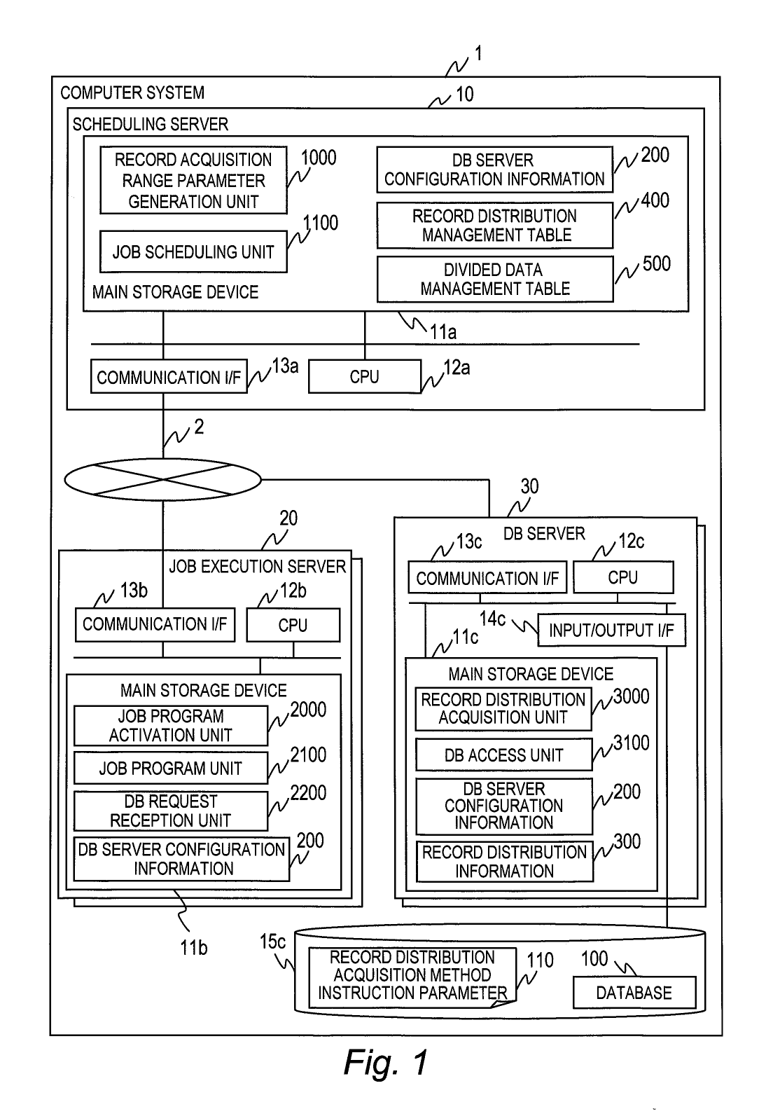

FIG. 1 illustrates an example of a hardware configuration of a computer system 1 according to the first embodiment of the present invention. The computer system 1 includes a scheduling server 10, one or more job execution servers 20, and one or more DB servers 30. A storage device 15c is connected to the DB servers 30.

The storage device 15c stores a database 100 which represents a set of records. It should be noted that a record is a unit of data in the database 100 that is acquired (input) and processed by job program units 2100. A numerical value or a character string of a specific field in a record is referred to as a key. In order to increase the processing speed of parallel execution, processing is executed separately for each divided data, namely a subset of data in the database 100 (record set), in units of execution such as a plurality of processes and tasks.

The scheduling server 10 includes a main storage device 11a, a central processing unit (CPU) 12a, and a communication I/ F 13a. This scheduling server 10 schedules jobs executed by the job execution servers 20. A job according to in the first embodiment of the present invention includes the acquisition of records stored in the database 100.

The main storage device 11a is a storage device, such as a random-access memory (RAM), that stores programs including instruction codes for realizing the functions of a record acquisition range parameter generation unit 1000 and a job scheduling unit 1100. This main storage device 11a also stores files and data that are necessary for the execution of programs, such as DB server configuration information 200, a record distribution management table 400, and a divided data management table 500. The CPU 12a is an arithmetic processing device that loads, interprets and executes programs stored in the main storage device 11a. The communication I/F 13a is an interface unit that transmits and receives execution requests and execution results to and from the job execution servers 20 and the DB servers 30 via a communication path 2.

The record acquisition range parameter generation unit 1000 generates a parameter for determining a range of records to be acquired from the database 100. The record acquisition range parameter generation unit 1000 also generates the divided data management table 500 based on the generated parameter. The operations of this record acquisition range parameter generation unit 1000 will be described later in detail. The job scheduling unit 1100 schedules jobs executed by the job execution servers 20 based on the parameter (divided data management table 500) generated by the record acquisition range parameter generation unit 1000. The job scheduling unit 1100 also requests the job execution servers 20 to execute the job program units 2100. The operations of this job scheduling unit 1100 will be described later in detail.

The DB server configuration information 200 manages configuration information of each DB server 30, that is to say, information showing a corresponding relationship between each DB server 30 and records in the database 100. This DB server configuration information 200 is collected by an arbitrary DB server 30 or job execution server 20. Furthermore, this DB server configuration information 200 holds the same contents in all of the scheduling server 10, the job execution servers 20 and the DB servers 30. This DB server configuration information 200 will be described later in detail.

The record distribution management table 400 is a table that manages information showing the distribution of records in the database 100. One example of the information showing the distribution of records is the number of records per key range (range of key values). This record distribution management table 400 will be described later in detail.

The divided data management table 500 is a table that manages information related to divided data, such as ranges and processing states of divided data. This divided data management table 500 will be described later in detail.

Each job execution server 20 includes a main storage device 11b, a CPU 12b, and a communication I/F 13b.

The main storage device 11b is a storage device, such as a RAM, that stores programs including instruction codes for realizing the functions of a job program activation unit 2000, a job program unit 2100, and a DB request reception unit 2200. This main storage device 11b also stores files and data that are necessary for the execution of programs, such as the DB server configuration information 200. The CPU 12b is an arithmetic processing device that loads, interprets and executes programs stored in the main storage device 11b. The communication I/F 13b is an interface unit that transmits and receives execution requests, record acquisition requests, and records to and from the scheduling server 10 and the DB servers 30 via the communication path 2.

The job program activation unit 2000 activates the job program unit 2100 upon receiving a request from the scheduling server 10. The operations of this job program activation unit 2000 will be described later in detail.

The job program unit 2100, which is activated by the job program activation unit 2000, applies processing to records in the database 100. This processing includes the acquisition of records from the database 100. The operations of this job program unit 2100 will be described later in detail.

The DB request reception unit 2200 transmits, for example, a request for the acquisition of records to a DB access unit 3100 upon receiving a request from the job program unit 2100. The operations of this DB request reception unit 2200 will be described later in detail.

Each DB server 30 includes a main storage device 11c, a CPU 12c, a communication I/F 13c, and an input/output I/F 14c, and is connected to the storage device 15c via the input/output I/F 14c.

The main storage device 11c is a storage device, such as a RAM, that stores programs including instruction codes for realizing the functions of a record distribution acquisition unit 3000 and a DB access unit 3100. This main storage device 11c also stores files and data that are necessary for the execution of programs, such as the DB server configuration information 200 and record distribution information 300. The CPU 12c is an arithmetic processing device that loads, interprets and executes programs stored in the main storage device 11c. The communication I/F 13c is a communication interface that transmits and receives a request for the acquisition of records and records to and from the job execution servers 20 via the communication path 2. The input/output I/F 14c is an interface unit for connecting to the storage device 15c that stores the database 100.

The record distribution acquisition unit 3000 generates the record distribution information 300 in accordance with a record distribution acquisition method instruction parameter 110. The operations of this record distribution acquisition unit 3000 will be described later in detail.

The DB access unit 3100 receives, for example, a request for the acquisition of records from the DB request reception unit 2200, and accesses the records in the database 100. The operations of this DB access unit 3100 will be described later in detail.

The record distribution information 300 is information showing the distribution of records in the database 100 managed by the DB servers 30. One example of the information showing the distribution of records is the number of records per key range. The contents of this record distribution information 300 vary with each DB server 30. This record distribution information 300 will be described later in detail.

The storage device 15c stores the database 100 and the record distribution acquisition method instruction parameter 110. The database 100 is used as described earlier. The record distribution acquisition method instruction parameter 110 is a parameter for instructing a method for acquiring the distribution of records to the record distribution acquisition unit 3000. This record distribution acquisition method instruction parameter 110 will be described later in detail.

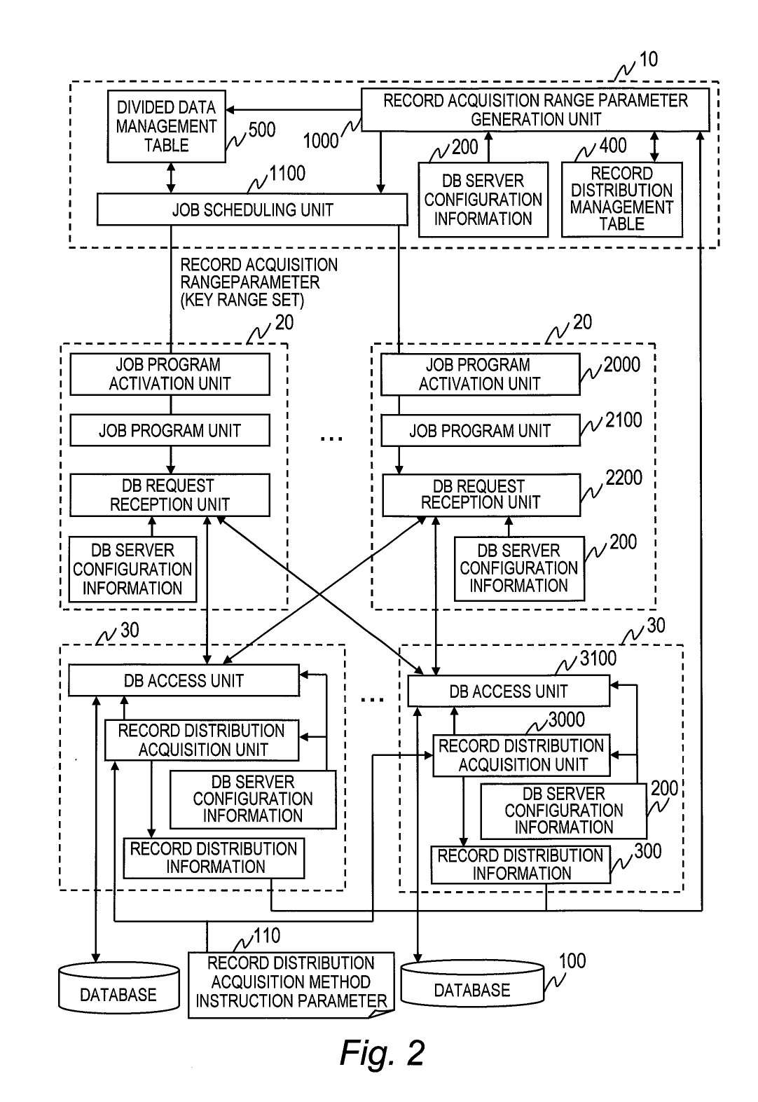

FIG. 2 is a block diagram illustrating the computer system 1 according to the first embodiment of the present invention. The following describes an overview of the operations of the computer system 1 with reference to FIG. 2.

The record distribution acquisition unit 3000 acquires information showing the distribution of records in the database 100 in accordance with the record distribution acquisition method instruction parameter 110, and outputs the acquired information as the record distribution information 300.

The record acquisition range parameter generation unit 1000 collects the record distribution information 300 from each DB server 30, and generates the record distribution management table 400 based on the collected record distribution information 300. The record acquisition range parameter generation unit 1000 also generates the divided data management table 500 based on the DB server configuration information 200 and the record distribution management table 400. Then, the job scheduling unit 1100 schedules jobs to be executed by each job execution server 20 based on the divided data management table 500, and requests the job program activation unit 2000 in each job execution server 20 to execute the job program unit 2100.

The job program activation unit 2000 activates the job program unit 2100. The activated job program unit 2100 requests the DB request reception unit 2200 to acquire records in the database 100. Upon receiving the request for the acquisition of records, the DB request reception unit 2200 transmits a request for the acquisition of records in the database 100 to the DB access unit 3100 in a DB server 30.

In response to the request from the DB request reception unit 2200, the DB access unit 3100 acquires records in the database 100 and returns the acquired records to the DB request reception unit 2200.

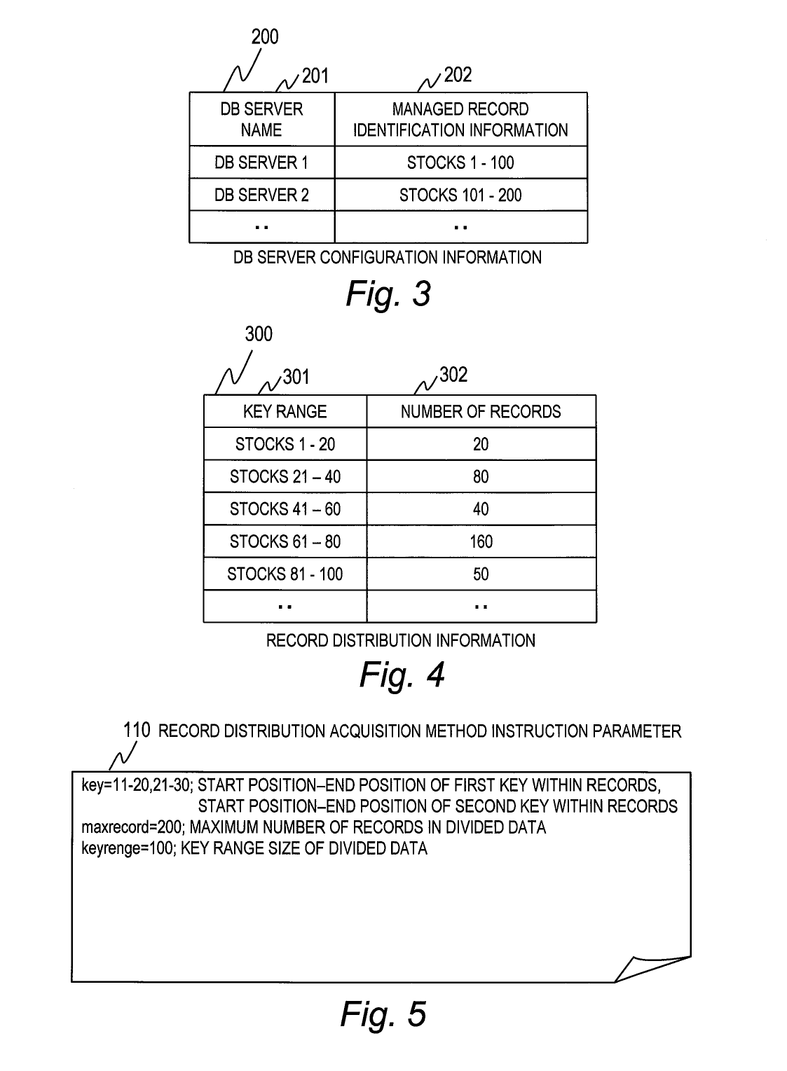

FIG. 3 illustrates an example of the DB server configuration information 200 according to the first embodiment of the present invention. The DB server configuration information 200 stores information showing records in the database 100 managed by each DB server 30.

A DB server name 201 is an identifier that uniquely identifies a DB server 30. Managed record identification information 202 is information for identifying records in the database 100 managed by the DB server 30 identified by the corresponding DB server name 201 (a range of key values of a key “stock” in FIG. 3).

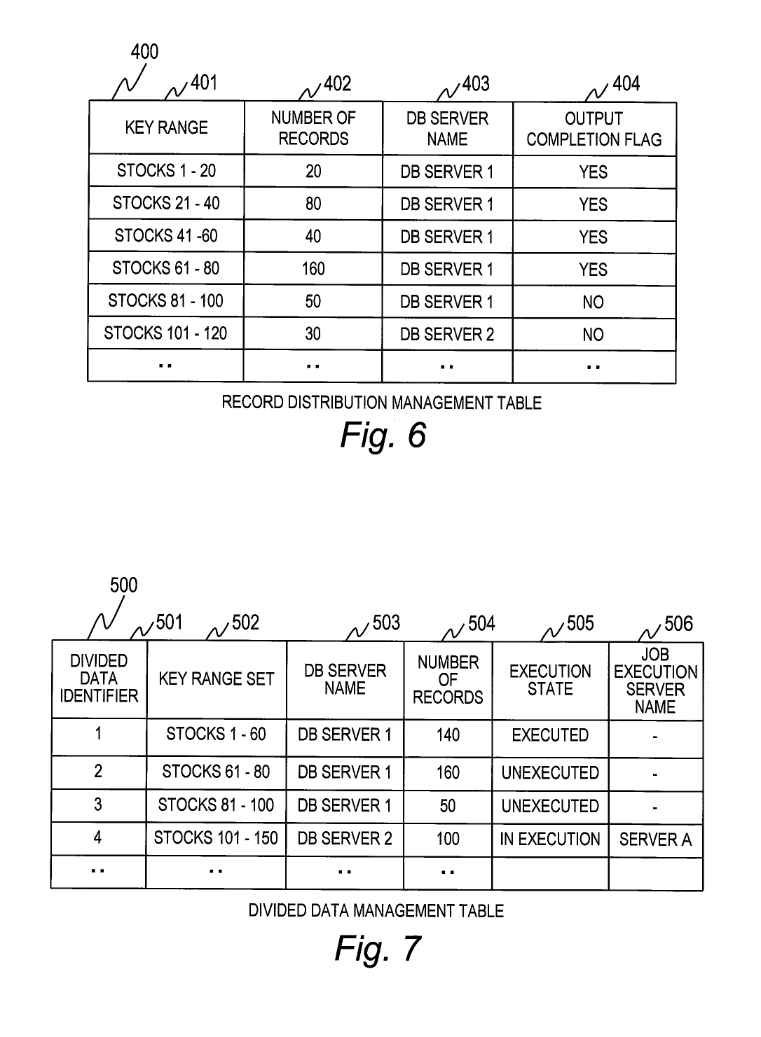

In case where a plurality of processes are executed and the management of records is segmentalized in units of processes in a DB server 30, the DB server name 201 may be an identifier showing a combination of an identifier for uniquely identifying that DB server 30 and an identifier for uniquely identifying a process. The same goes for a DB server name 403 illustrated in FIG. 6 and a DB server name 503 illustrated in FIG. 7.

As described above, the DB server configuration information 200 stores information showing a range of key values included in the records in the database 100 managed by each DB server 30.

FIG. 4 illustrates an example of the record distribution information 300 according to the first embodiment of the present invention. The record distribution information 300 stores the number of records per key range as information showing the distribution of records in the database 100.

A key range 301 is a range of key values of records. The number of records 302 is the number of records whose key values fall within the corresponding key range 301.

In case where a plurality of processes are executed and the management of records is segmentalized in units of processes in a DB server 30, entries of the record distribution information 300 may include identifiers of the processes.

FIG. 5 illustrates an example of the record distribution acquisition method instruction parameter 110 according to the first embodiment of the present invention. The record distribution acquisition method instruction parameter 110 is a parameter for instructing a method for acquiring the distribution of records in the database 100 to the record distribution acquisition unit 3000.

The record distribution acquisition method instruction parameter 110 illustrated in FIG. 5 defines, as a method for acquiring the distribution of records in the database 100, the offset positions of the first key within the records in the database 100 (the acquisition start position to the acquisition end position), that is to say, the key positions for each distribution (section). In the example illustrated in FIG. 5, the 11th column and the 20th column are respectively defined as the acquisition start position and the acquisition end position of the first key within the records.

In case where the database 100 is expected to store a large number of records with the same first key, the offset positions of the second key within the records in the database 100 may be defined. In the example illustrated in FIG. 5, the 21st column and the 30th column are respectively defined as the acquisition start position and the acquisition end position of the second key within the records.

The record distribution acquisition method instruction parameter 110 also defines the maximum number of records in divided data. The maximum number of records in divided data denotes the maximum number of records stored in one piece of divided data in case where divided data is generated based on the distribution of records acquired. That is to say, the number of records held in one piece of divided data is smaller than or equal to this maximum number of records. In the example of FIG. 5, 200 is defined as the maximum number of records in divided data.

The record distribution acquisition method instruction parameter 110 further defines a key range size of divided data. This key range size of divided data is information used to determine a key range size for each distribution (each section) in case of acquiring the distribution of records. A key range size of each section is obtained by dividing this key range size of divided data by a value n of a pre-set integer constant. In the example of FIG. 5, 100 is defined as a key range size of divided data. Provided that a key range size of each section is obtained by dividing this key range size (100) by the value of the integer constant (5), the key range size of each section is 20 as illustrated in FIG. 4.

Instead of a key range size of divided data, a key range size of each section may be defined. More specifically, a key range size of each section may be obtained under the assumption that one section corresponds to a key value size, with the first section starting from the smallest key value. Alternatively, the number of divisions may be defined. More specifically, a key range size of each section may be obtained by (a) dividing a key range of the entire database 100 by the number of divisions, then (b) dividing the result of (a) by the value n of the integer constant. For example, the number of divisions denotes the number of divided jobs, that is to say, the number of sub-jobs executed by the job execution servers 20. The record distribution acquisition method instruction parameter 110 may further define other information for identifying the database 100.

FIG. 6 illustrates an example of the record distribution management table 400 according to the first embodiment of the present invention. The record distribution management table 400 is generated by the record acquisition range parameter generation unit 1000 based on the record distribution information 300 in each DB server 30 (see FIG. 4).

A key range 401 is a range of key values of records. The key ranges 301 in the record distribution information 300 are stored under the key ranges 401. The number of records 402 is the number of records whose key values fall within the corresponding key range 401. The numbers of records 302 in the record distribution information 300 are stored under the numbers of records 402.

A DB server name 403 stores the name of a DB server 30 that manages the record distribution information 300. An output completion flag 404 is a flag for identifying whether or not an entry of a key range set including a key range of values shown by the key range 401 has been output to the later-described divided data management table 500 (see FIG. 7). This output completion flag 404 stores “NO” as a default value.

FIG. 7 illustrates an example of the divided data management table 500 according to the first embodiment of the present invention. The divided data management table 500 is generated by the record acquisition range parameter generation unit 1000 based on the record distribution management table 400 and the DB server configuration information 200.

A divided data identifier 501 is an identifier, such as a sequence number, for uniquely identifying divided data. A key range set 502 is a combination of ranges of key values of records in divided data. A DB server name 503 is the name of a DB server 30 to connect so as to acquire records in divided data managed by that DB server 30. The number of records 504 shows the number of records in divided data. An execution state 505 stores one of “EXECUTED”, “IN EXECUTION” and “UNEXECUTED” as a state of execution of processing for divided data. A job execution server name 506 is a character string for uniquely identifying a job execution server 20 on which the processing for divided data is in execution.

In case where the execution state 505 shows “EXECUTED”, it means that the job program unit 2100 has completed the processing for divided data. In case where the execution state 505 shows “IN EXECUTION”, it means that the job scheduling unit 1100 has issued a request for the processing of divided data to the job program activation unit 2000 but the job program unit 2100 has not completed the processing of divided data. In case where the execution state 505 shows “UNEXECUTED”, it means that the job scheduling unit 1100 has not issued a request for the processing of divided data to the job program activation unit 2000.

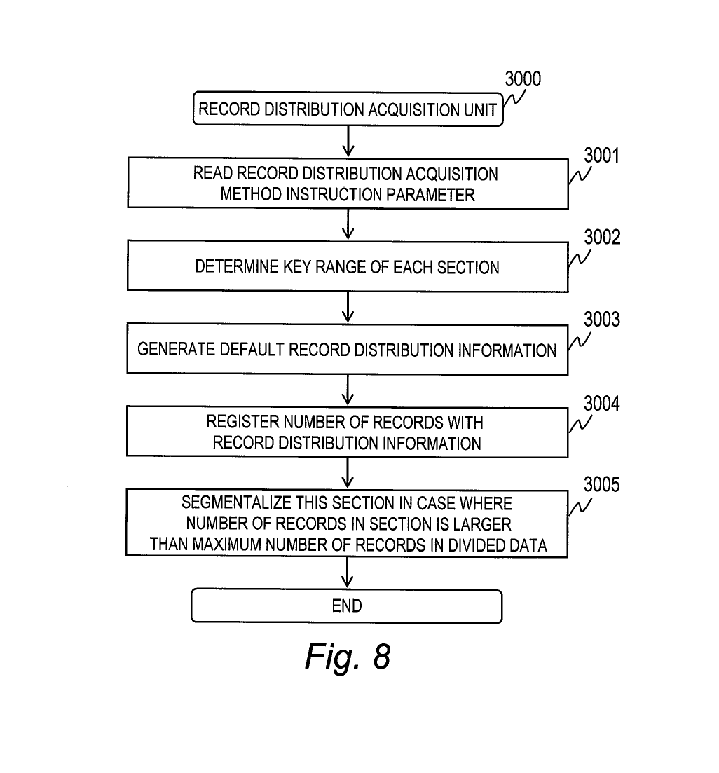

FIG. 8 is a flowchart of control logic of the record distribution acquisition unit 3000 according to the first embodiment of the present invention.

First, the record distribution acquisition unit 3000 reads the record distribution acquisition method instruction parameter 110 (Step 3001). By reading the record distribution acquisition method instruction parameter 110, the record distribution acquisition unit 3000 acquires information defined in the record distribution acquisition method instruction parameter 110, such as key positions in each section, the maximum number of records in divided data, and the key range size of divided data for determining a key range size of each section.

Next, the record distribution acquisition unit 3000 determines a key range (the smallest value and the largest value) of each section (Step 3002). Here, a key range size of each section is obtained by dividing the key range size of divided data defined in the record distribution acquisition method instruction parameter 110 by a value n of a pre-set integer constant. Thereafter, the key range of each section is set per key range size, starting from the smallest key value of the records.

A key range set 502 (see FIG. 7) for one piece of divided data is generated by combining key ranges of a plurality of sections. Therefore, in this Step 3002, the key range size of each section is set to be smaller than the key range size of divided data by dividing the defined key range size of divided data by the value n (approximately 5 to 10) of the integer constant. In case where the record distribution acquisition method instruction parameter 110 defines the number of divisions instead of the key range size of divided data, the key range size of each section may be obtained in Step 3002 by dividing “the largest key value−the smallest key value” of all records in the database 100 by {(the number of divisions)×(the value n of the integer constant)}.

Next, the record distribution acquisition unit 3000 generates default record distribution information 300 (Step 3003). The key range (the smallest value and the largest value) of each section determined in Step 3002 is substituted into the key range 301. A default value 0 is substituted into the number of records 302.

Thereafter, the record distribution acquisition unit 3000 obtains the number of records included in each section determined in Step 3002, and registers the obtained number of records under the number of records 302 (Step 3004). For example, for each record in the database 100, the record distribution acquisition unit 3000 adds one to the number of records 302 in an entry of the key range 301 including the key value of that record. Also, in case of storing a record in the database 100, the record distribution acquisition unit 3000 adds one to the number of records 301 in an entry of the key range 301 including the key value of that record to be stored.

Next, in case where the number of records 302 in a predetermined section (key range 301) is larger than the maximum number of records in divided data defined in the record distribution acquisition method instruction parameter 110, the record distribution acquisition unit 3000 segmentalizes this section (Step 3005). More specifically, the record distribution acquisition unit 3000 segmentalizes a section including more records than is defined by the maximum number of records in divided data by re-setting the key range size for this section to 1/n, and re-counts the number of records included in each segmentalized section. In case where a segmentalized section has a key range size of one, the record distribution acquisition unit 3000 sets sections using values of the second key defined in the record distribution acquisition method instruction parameter 110.

Through the above-described processing, the record distribution acquisition unit 3000 divides a range of key values of records in the database 100 into a plurality of sections based on the record distribution acquisition method instruction parameter 110, acquires the number of records in each divided section as information showing the distribution of records, and outputs the acquired number of records as the record distribution information 300.

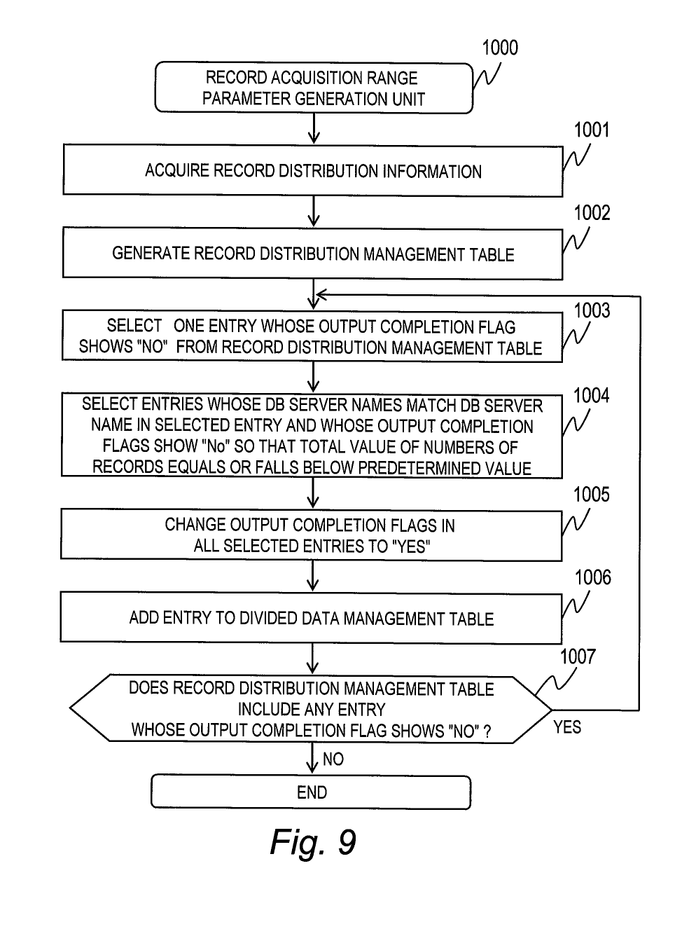

FIG. 9 is a flowchart of control logic of the record acquisition range parameter generation unit 1000 according to the first embodiment of the present invention.

First, the record acquisition range parameter generation unit 1000 acquires the record distribution information 300 from each DB server 30 (Step 1001). More specifically, the record acquisition range parameter generation unit 1000 loads the DB server configuration information 200 stored in an arbitrary DB server 30 to the main storage device 11a, and acquires the record distribution information 300 from each DB server 30 registered with the DB server configuration information 200.

Then, the record acquisition range parameter generation unit 1000 generates the record distribution management table 400 based on the record distribution information 300 of each DB server 30 acquired in Step 1001 (Step 1002).

More specifically, the record acquisition range parameter generation unit 1000 first generates an entry of the record distribution management table 400 per entry of the record distribution information 300 of each DB server 30 acquired in Step 1001. The record acquisition range parameter generation unit 1000 then substitutes the key ranges 301 and the numbers of records 302 in the record distribution information 300 into the key ranges 401 and the numbers of records 402, respectively. The record acquisition range parameter generation unit 1000 also substitutes the names of the DB servers 30 from which the record distribution information 300 was acquired into the DB server names 403. The record acquisition range parameter generation unit 1000 further substitutes a default value “NO” into the output completion flags 404.

Next, the record acquisition range parameter generation unit 1000 selects, from the record distribution management table 400, one arbitrary entry whose output completion flag 404 shows “NO” (Step 1003).

Thereafter, the record acquisition range parameter generation unit 1000 selects entries whose DB server names 403 match the DB server name 403 in the entry selected in Step 1003 and whose output completion flags 404 show “NO”, until the total value of the numbers of records 402 hits the maximum number of records in divided data (Step 1004).

It should be noted that the record acquisition range parameter generation unit 1000 acquires the maximum number of records in divided data in case of acquiring the DB server configuration information 200 or the record distribution information 300 from the DB servers 30. Alternatively, the record acquisition range parameter generation unit 1000 may acquire the maximum number of records in divided data by reading the record distribution acquisition method instruction parameter 110.

Then, the record acquisition range parameter generation unit 1000 changes the output completion flags 404 of all entries selected from the record distribution management table 400 in Steps 1003 and 1004 to “YES” (Step 1005).

Subsequently, the record acquisition range parameter generation unit 1000 adds a new entry to the divided data management table 500 and registers information related to divided data therewith (Step 1006). More specifically, the record acquisition range parameter generation unit 1000 sets a key range (a range of divided data, namely a range of division) obtained by combining the key ranges 401 of all entries selected in Steps 1003 and 1004 to the key range set 502, the DB server name 403 of these entries to the DB server name 503, and the total value of the numbers of records 402 of these entries to the number of records 504. The record acquisition range parameter generation unit 1000 also sets a sequence number to the divided data identifier 501. Note that this sequence number is determined under the assumption that the sequence number “1” is set to the divided data identifier 501 of the first entry. The record acquisition range parameter generation unit 1000 further sets a default value “UNEXECUTED” to the execution state 505.

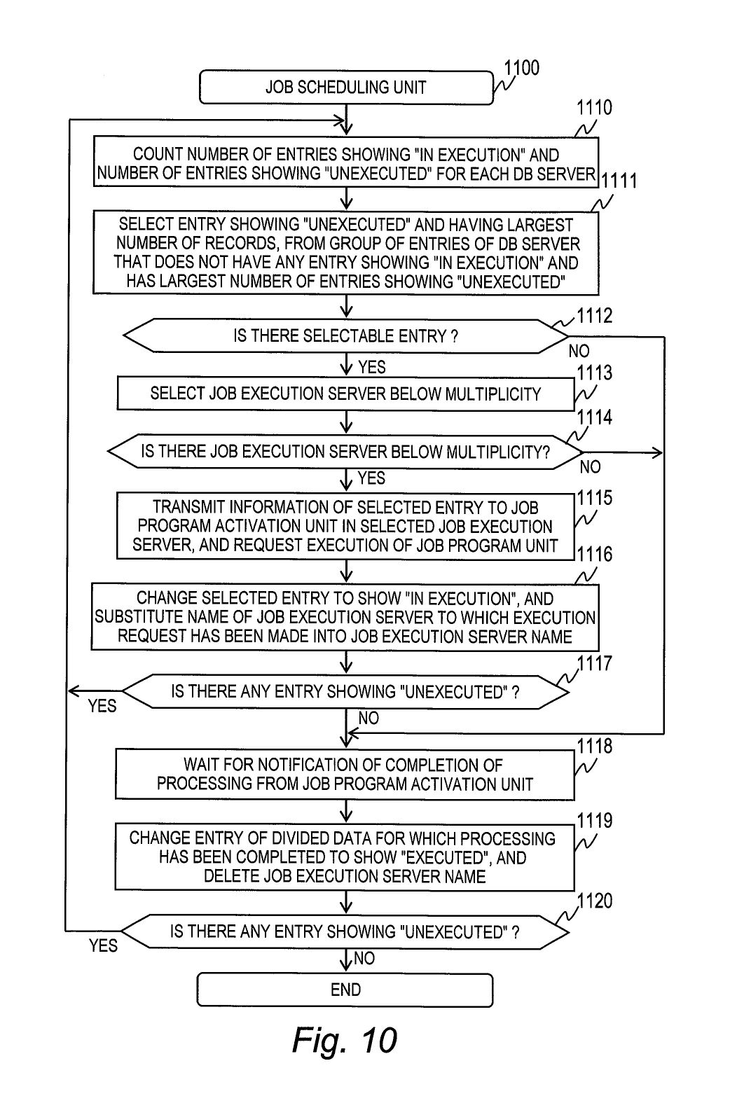

In Step 1006, the record acquisition range parameter generation unit 1000 may output the key range set 502, the DB server name 503 and the number of records 504 to a file instead of registering the information related to divided data with the divided data management table 500. In this case, prior to Step 1110 (see FIG. 10), the job scheduling unit 1100 reads the key range set 502, the DB server name 503 and the number of records 504 from the output file, adds a new entry to the divided data management table 500, and registers the read pieces of information therewith.

Next, the record acquisition range parameter generation unit 1000 determines whether or not the record distribution management table 400 includes any entry whose output completion flag 404 shows “NO” (Step 1007). In case where the record distribution management table 400 includes an entry whose output completion flag 404 shows “NO” (the Yes branch of Step 1007), the processing returns to Step 1003. On the other hand, in case where the record distribution management table 404 does not include any entry whose output completion flag 400 shows “NO” (the No branch of Step 1007), the processing is ended. Through the above-described processing, especially in Steps 1003 to 1006, the record acquisition range parameter generation unit 1000 refers to the DB server configuration information 200 and the record distribution management table 400, and combines key ranges of records managed by the same DB server 30 so that, after the combination, the numbers of records are equalized in such a way as to match or fall below the maximum number of records in divided data. This makes it possible to prevent the combination and co-existence of records managed by different DB servers 30. Thereafter, the key range set 502, which is a set of combined key ranges, and the DB server name 503, which is the identifier of the DB server 30, are associated with each other and stored in the divided data management table 500.

FIG. 10 is a flowchart of control logic of the job scheduling unit 1100 according to the first embodiment of the present invention.

First, the job scheduling unit 1100 refers to all entries in the divided data management table 500, and counts the number of entries whose execution states 505 show “IN EXECUTION” and the number of entries whose execution states 505 show “UNEXECUTED” per group of entries with the same DB server name 503 (Step 1110).

Next, the job scheduling unit 1100 obtains the DB server name 503 that does not have any entry whose execution state 505 shows “IN EXECUTION” and has the largest number of entries whose execution states 505 show “UNEXECUTED”, and preferentially selects, from a group of entries of the obtained DB server name 503, an entry with the execution state 505 showing “UNEXECUTED” and the largest number of records 504 (Step 1111).

In case where there is an entry that can be selected in Step 1112, that is to say, in case where there is a group of entries of a DB server name 503 that does not include any entry whose execution state 505 shows “IN EXECUTION” and includes one or more entries whose execution states 505 show “UNEXECUTED”, the job scheduling unit 1100 executes the following Steps 1113 to 1117 (Step 1112).

It should be noted that, in case where each DB server 30 executes a plurality of processes, allows multiple connections simultaneously and can execute multiple inputs/outputs to a database in parallel, the job scheduling unit 1100 may select entries of a DB server 30 that satisfy the following condition in Step 1112: the number of entries whose execution states 505 show “IN EXECUTION” is smaller than the number of connections allowed.

After proceeding to Step 1113, the job scheduling unit 1100 refers to all entries in the divided data management table 500, counts the number of entries per job execution server name 506, and obtains a job execution server name 506 that satisfies the following condition: the number of entries whose execution states 505 show “IN EXECUTION” is smaller than a pre-set multiplicity (the largest number of execution units of the job program unit 2100 that can be simultaneously executed in the same job execution server 20) (Step 1113).

The job scheduling unit 1100 proceeds to Step 1115 in case where there is a job execution server name 506 that satisfies the following condition: the number of entries whose execution states 505 show “IN EXECUTION” is smaller than the multiplicity (YES in Step 1114). On the other hand, the job scheduling unit 1100 proceeds to Step 1118 in case where there is no job execution server name 506 that satisfies the following condition: the number of entries whose execution states 505 show “IN EXECUTION” is smaller than the multiplicity (NO in Step 1114).

After proceeding to Step 1115, the job scheduling unit 1100 transmits information of the entry selected in Step 1111 to the job program activation unit 2000 in the job execution server 20 selected in Step 1113, and requests that job program activation unit 2000 to execute the job program unit 2100 (Step 1115). This information of the entry denotes information of the divided data identifier 501 and the key range set (record acquisition range parameter) 502 in the entry.

Next, the job scheduling unit 1100 changes the execution state 505 of the entry selected in Step 1111 to “IN EXECUTION”, and substitutes the name of the job execution server 20 to which the request for the execution has been made into the job execution server name 506 of the same entry (Step 1116).

Thereafter, the job scheduling unit 1100 determines whether or not the divided data management table 500 includes any entry whose execution state 505 shows “UNEXECUTED” (Step 1117). In case where there is an entry whose execution state 505 shows “UNEXECUTED” (the Yes branch of Step 1117), the job scheduling unit 1100 returns to Step 1110. On the other hand, in case where there is no entry whose execution state 505 shows “UNEXECUTED” (No in Step 1117), the job scheduling unit 1100 proceeds to Step 1118.

After proceeding to Step 1118, the job scheduling unit 1100 waits for a notification of completion of processing of divided data from the job program activation unit 2000 (Step 1118). Then, upon receiving the notification of completion of processing from the job program activation unit 2000, the job scheduling unit 1100 changes the execution state 505 of the entry of the divided data for which processing has been completed to “EXECUTED”, and deletes the name of the job execution server 20 substituted into the job execution server name 506 (Step 1119). Thereafter, the job scheduling unit 1100 determines whether or not the divided data management table 500 includes any entry whose execution state 505 shows “UNEXECUTED” (Step 1120). In case where there is an entry whose execution state 505 shows “UNEXECUTED” (the Yes branch of Step 1120), the processing returns to Step 1110. On the other hand, in case where there is no entry whose execution state 505 shows “UNEXECUTED” (NO in Step 1120), the processing is ended.

Through the above-described processing, the job scheduling unit 1100 extracts entries whose execution states 505 show “UNEXECUTED” one by one from the divided data management table 500. The job scheduling unit 1100 then transmits information of the extracted entries to the job program activation unit 2000 and requests the job program activation unit 2000 to execute the job program unit 2100. The processes of Steps 1110 to 1112 restrict simultaneous execution of the same entry by the same DB server 30. In this way, contention over access to each DB server 30 can be prevented even in case where the relationships between the job execution servers 20 and the DB servers 30 are not fixed or in case where the number of the job execution servers 20 and the number of the DB servers 30 are not equal.

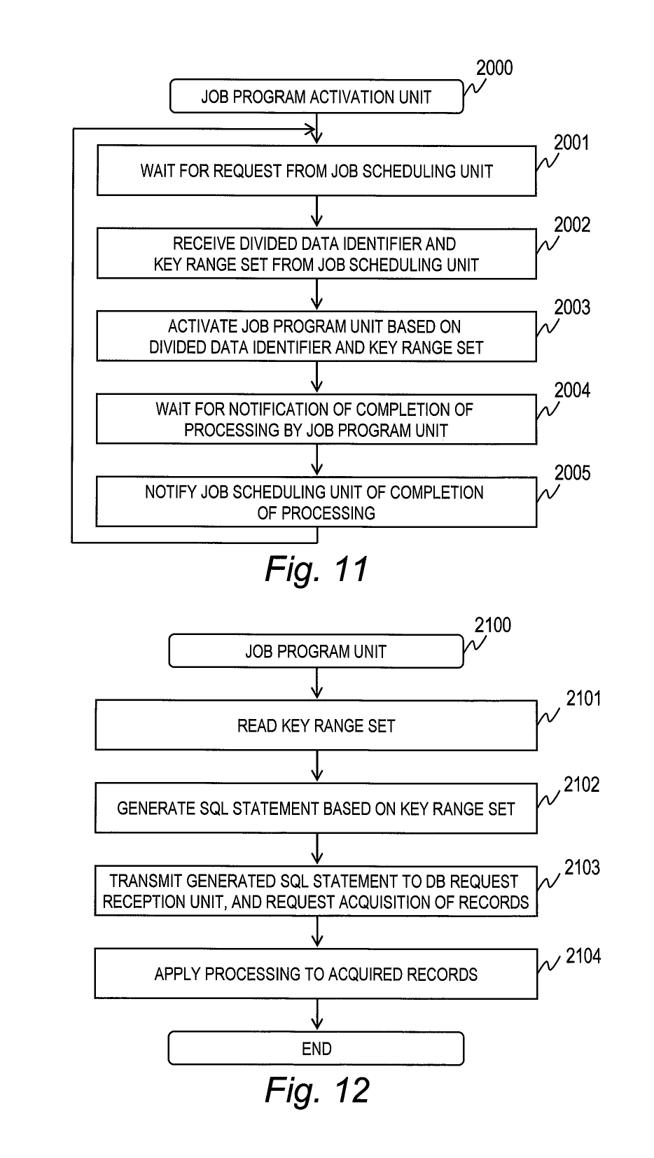

FIG. 11 is a flowchart of control logic of the job program activation unit 2000 according to the first embodiment of the present invention.

First, the job program activation unit 2000 waits for a request from the job scheduling unit 1100 (Step 2001). Upon receiving the request from the job scheduling unit 1100, the job program activation unit 2000 receives the divided data identifier 501 and the key range set 502 from the job scheduling unit 1100 (Step 2002).

Then, the job program activation unit 2000 sets the divided data identifier 501 and the key range set 502 received in Step 2002 to an area that the job program unit 2100 can refer to (for example, an environment variable), and activates the job program unit 2100 (Step 2003).

Next, the job program activation unit 2000 waits for a notification of completion of processing of divided data in the database 100 from the job program unit 2100 (Step 2004). Upon receiving the notification of completion of processing from the job program unit 2100, the job program activation unit 2000 transmits the divided data identifier 501 of divided data for which processing has been completed to the job scheduling unit 1100, and notifies the job scheduling unit 1100 of the completion of the processing of the divided data (Step 2005).

FIG. 12 is a flowchart of control logic of the job program unit 2100 according to the first embodiment of the present invention.

First, the job program unit 2100 reads the key range set 502 set to the environment variable and the like by the job program activation unit 2000 (Step 2101). Then, the job program unit 2100 generates a Structured Query Language (SQL) statement for acquiring records in the database 100 by embedding the key range set 502 read in Step 2101 in an operand in a SELECT statement in SQL (Step 2102).

Next, the job program unit 2100 transmits, to the DB request reception unit 2200, the SQL statement generated in Step 2102 together with a request for acquisition of records falling within a range designated by the operand in the SQL statement from the database 100 (Step 2103). The job program unit 2100 then waits for a response from the DB request reception unit 2200.

Thereafter, the job program unit 2100 receives a response from the DB request reception unit 2200, extracts the acquired records from a response area storing the result of the response from the DB request reception unit 2200, and applies program-specific processing to the extracted records (Step 2104). This program-specific processing is, for example, processing for making the extracted records modified, summarized, and organized into a form.

Through the above-described processing, the job program unit 2100 generates a parameter for requesting the acquisition of records in the database 100 in a format that can be interpreted by the DB request reception unit 2200, such as a SELECT statement in SQL, with the use of the key range set 502, and transmits the generated parameter to the DB request reception unit 2200.

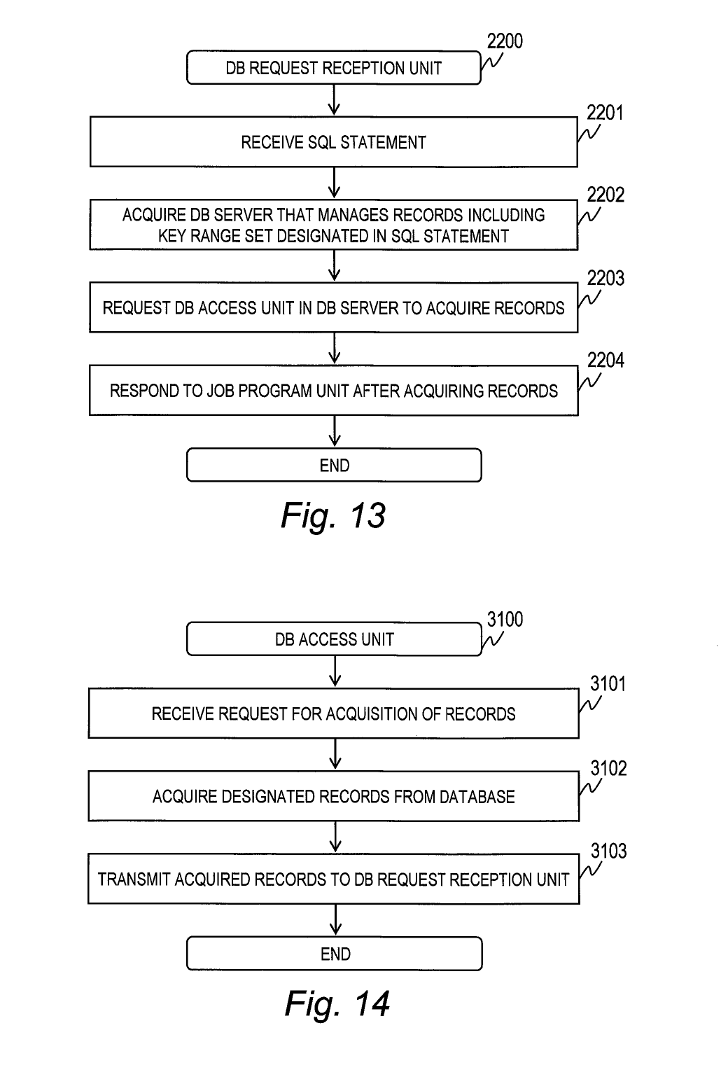

FIG. 13 is a flowchart of control logic of the DB request reception unit 2200 according to the first embodiment of the present invention.

First, the DB request reception unit 2200 receives an SQL statement from the job program unit 2100 (Step 2201). Next, the DB request reception unit 2200 compares the key range set 502 described in the operand in the SQL statement received in Step 2201 with the pieces of managed record identification information 202 in the DB server configuration information 200, and obtains a DB server name 201 corresponding to a piece of managed record identification information 202 including the key range set 502 (Step 2202).

The DB request reception unit 2200 then transmits information of the key range set 502 to the DB access unit 3100 in the DB server 30 with the DB server name 201 obtained in Step 2202, and requests that DB access unit 3100 to acquire records (Step 2203).

Thereafter, the DB request reception unit 2200 stores the records acquired by the DB access unit 3100 in the response area, and responds to the job program unit 2100 that has transmitted the SQL statement (Step 2204).

Through the above-described processing, the DB request reception unit 2200 refers to the DB server configuration information 200, selects a DB server 30 that manages records including the key range set 502 designated in the SQL statement, and transmits a request for acquisition of the records in the database 100 to the DB access unit 3100 in the selected DB server 30.

FIG. 14 is a flowchart of control logic of the DB access unit 3100 according to the first embodiment of the present invention.

First, the DB access unit 3100 receives a request for acquisition of records (including the information of the key range set 502) from the DB request reception unit 2200 (Step 3101).

Next, the DB access unit 3100 acquires, from the database 100, the records of the key range set 502 designated in the request for acquisition of records received in Step 3101 (Step 3102). Then, the DB access unit 3100 transmits the records acquired in Step 3102 to the DB request reception unit 2200 in a format such as an SQL response statement (Step 3103).

Through the above-described processing, the DB access unit 3100 extracts records of the designated key range set 502 from the database 100 and transmits the extracted records to the DB request reception unit 2200.

As described above, in parallel distributed processing of jobs that include the input of data stored in the database 100, the computer system 1 of the first embodiment of the present invention can prevent contention over access to a DB server 30 that inputs data stored in the database 100 even if the relationships between the DB servers 30 and the job execution servers 20 are not fixed or if the number of the DB servers 30 and the number of the job execution servers 20 are not equal.

Furthermore, the number of records processed by each job execution server 20 can be appropriately adjusted, and the number of processed records can be balanced among the job execution servers 20. As a result, the loads on the job execution servers 20 and the DB servers 30 can be balanced, thus enabling high-speed execution of jobs.

### Second Embodiment

The above first embodiment has described the execution of jobs including the acquisition of records stored in the database 100 by the job execution servers 20. The present embodiment describes the execution of jobs including the output (storage) of records to the database 100 by the job execution servers 20.

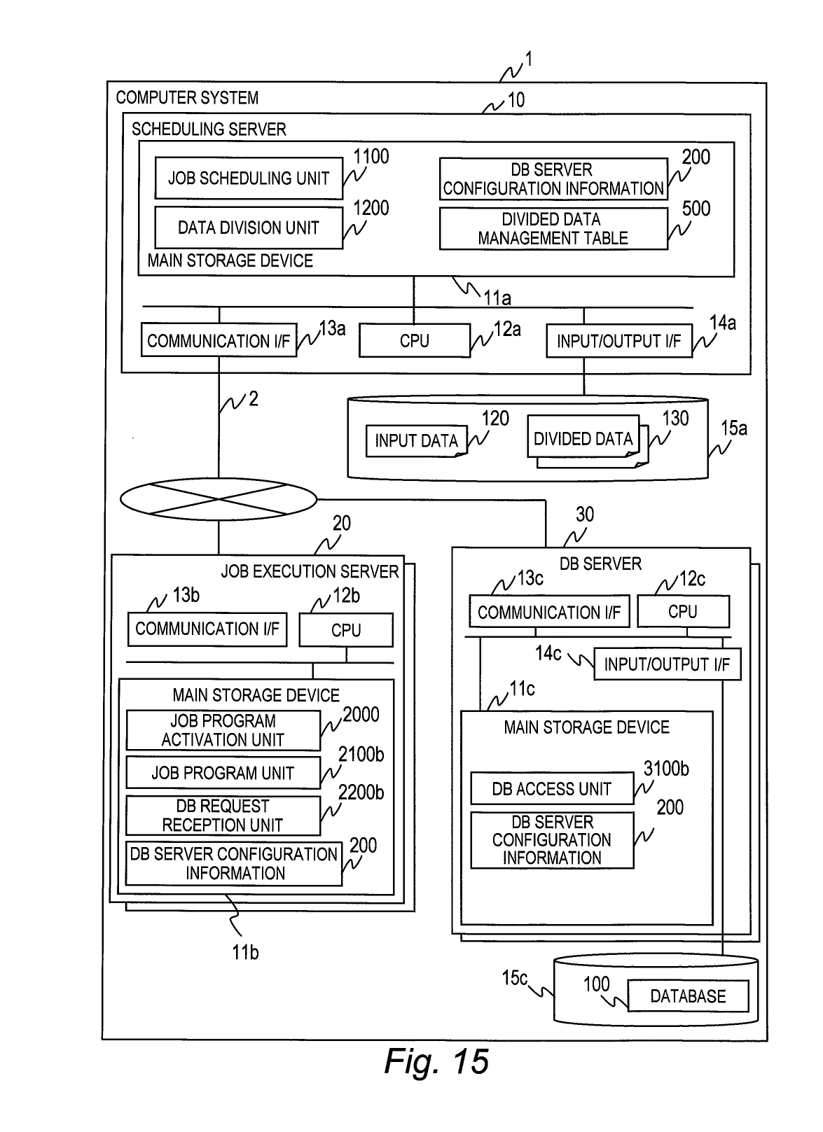

FIG. 15 illustrates an example of a hardware configuration of a computer system 1 according to the second embodiment of the present invention. The computer system 1 includes a scheduling server 10, one or more job execution servers 20, and one or more DB servers 30. Below, constituent elements that are similar to those illustrated in FIG. 1 are assigned the same reference signs thereas, and descriptions that have already been given above are omitted as appropriate.

The scheduling server 10 of the second embodiment of the present invention further includes an input/output I/F 14a. This scheduling server 10 schedules jobs executed by the job execution servers 20. These jobs include the output of records to the database 100. This scheduling server 10 is connected to a storage device 15a via the input/output I/F 14a.

The storage device 15a stores input data 120 and divided data 130. The input data 120 is a set of records processed by job program units 2100. The divided data 130 is obtained by dividing the input data 120. This storage device 15a is directly connected to the scheduling server 10. Alternatively, this storage device 15a may be indirectly connected to the scheduling server 10 via a network and the like.

The main storage device 11a is a storage device, such as a RAM, that stores programs including instruction codes for realizing the functions of a job scheduling unit 1100 and a data division unit 1200. This main storage device 11a also stores files and data that are necessary for the execution of programs, such as DB server configuration information 200 and a divided data management table 500.

The job scheduling unit 1100 schedules jobs to be executed by the job execution servers 20 based on the divided data management table 500.

The job scheduling unit 1100 also requests the job execution servers 20 to execute the job program units 2100. The operations of this job scheduling unit 1100 are similar to the above-described first embodiment (see FIG. 10) except for the following features. Therefore, the following only describes features of the operations of the job scheduling unit 1100 that are different from the above-described first embodiment.

In Step 1115, the job scheduling unit 1100 of the second embodiment of the present invention transmits information of divided data 130 to be output to the database 100 to the job program activation unit 2000 in the job execution server 20 selected in Step 1113, and requests that job program activation unit 2000 to execute the job program unit 2100 (Step 1115). The divided data 130 to be output to the database 100 denotes one piece of divided data 130 selected in Step 1111 from among pieces of divided data 130 registered with the divided data management table 500. Through the processes of Steps 1110 to 1112, the job scheduling unit 1100 refers to the DB server names 503 in the divided data management table 500 and restricts the same DB server 30 from processing the same divided data 130 simultaneously. Also, through the process of Step 1111, divided data 130 including a large number of records is preferentially selected.

The data division unit 1200 divides the input data 120 into a plurality of pieces of divided data 130. The operations of this data division unit 1200 will be described later in detail.

The DB server configuration information 200 manages configuration information of each DB server 30. The divided data management table 500 is a table that manages information related to each divided data 130 generated by the data division unit 1200, such as a range and a processing state of each divided data 130. These DB server configuration information 200 and divided data management table 500 are similar to those described in the above first embodiment (see FIGS. 3 and 7), and therefore a description thereof is omitted below.

As with the above-described first embodiment, each job execution server 20 includes a main storage device 11b, a CPU 12b, and a communication I/F 13b.

The main storage device 11b is a storage device, such as a RAM, that stores programs including instruction codes for realizing the functions of a job program activation unit 2000, a job program unit 2100b, and a DB request reception unit 2200b.

The job program activation unit 2000 activates the job program unit 2100 upon receiving a request from the scheduling server 10. This job program activation unit 2000 is similar to the one described in the above first embodiment (see FIG. 11) except for the following features. Therefore, the following only describes features of the job program activation unit 2000 that are different from the above-described first embodiment.

In Step 2002, the job program activation unit 2000 of the second embodiment of the present invention may receive divided data 130 instead of receiving the key range set (record acquisition range parameter) 502. Furthermore, in Step 2003, the job program activation unit 2000 does not set the divided data 130 received in Step 2002 to an area that the job program unit 2100 can refer to (for example, an environment variable).

The job program unit 2100b, which is activated by the job program activation unit 2000, applies processing to records in the database 100. This processing includes the output of records to the database 100. The operations of this job program unit 2100b will be described later in detail.

Upon receiving a request from the job program unit 2100, the DB request reception unit 2200b transmits, for example, a request for the output of records to a DB access unit 3100. The operations of this DB request reception unit 2200b will be described later in detail.

As with the above-described first embodiment, each DB server 30 includes a main storage device 11c, a CPU 12c, a communication I/F 13c, and an input/output I/F 14c. Each DB server 30 is connected to the storage device 15c via the input/output I/F 14c.

The main storage device 11c is a storage device, such as a RAM, that stores programs including instruction codes for realizing the functions of the DB access unit 3100. This main storage device 11c also stores files and data that are necessary for the execution of programs, such as the DB server configuration information 200.

The storage device 15c stores the database 100 which represents a set of records. It should be noted that a record is a unit of data in the database 100 that is output (stored) and processed by the job program units 2100. A numerical value or a character string of a specific field in a record is referred to as a key.

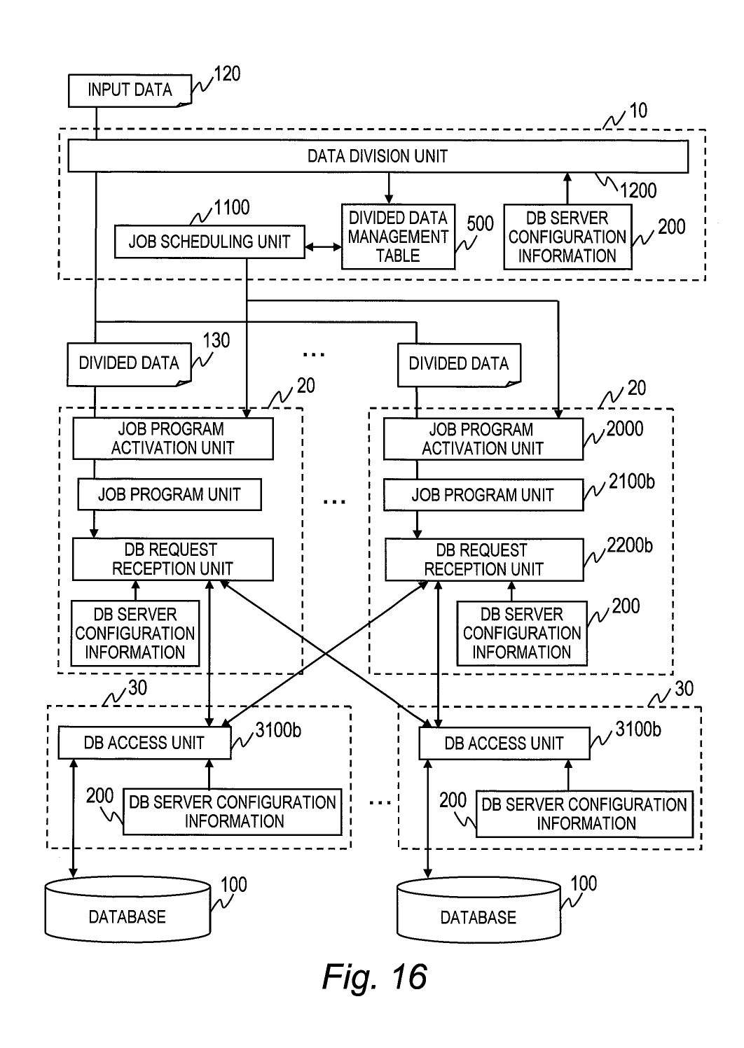

FIG. 16 is a block diagram illustrating the computer system 1 according to the second embodiment of the present invention. The following describes an overview of the operations of the computer system 1 with reference to FIG. 16.

The data division unit 1200 divides input data 120 into a plurality of pieces of divided data 130, and registers attribute information of the plurality of pieces of divided data 130 with the divided data management table 500. Then, the job scheduling unit 1100 schedules jobs to be executed by each job execution server 20 based on the divided data management table 500, and requests the job program activation unit 2000 in each job execution server 20 to execute the job program unit 2100.

The job program activation unit 2000 activates the job program unit 2100b. The activated job program unit 2100b reads and processes divided data 130, and transmits, to the DB request reception unit 2200b, a request for the output of records obtained as a processing result to the database 100.

Upon receiving the request for the output of records, the DB request reception unit 2200b transmits, to the DB access unit 3100 of the DB server 30, a request for the output of records to the database 100.

In response to the request from the DB request reception unit 2200b, the DB access unit 3100b outputs the records to the database 100 and returns a response to the DB request reception unit 2200b.

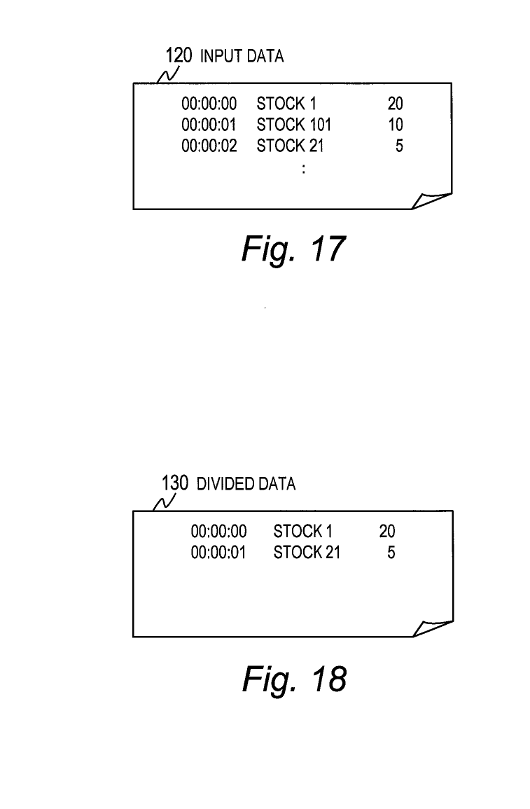

FIG. 17 illustrates an example of input data 120 according to the second embodiment of the present invention.

Input data 120 is a record group composed of a plurality of records. Each record includes information such as transaction time (“00:00:00” in the first record of FIG. 17), a transaction stock name which is a key of the record (“STOCK 1”), and the number of transactions (“20”).

FIG. 18 illustrates an example of divided data 130 according to the second embodiment of the present invention. Divided data 130 is composed of one or more records included in the input data 120. As contents of each record are similar to the input data 120, a description thereof is omitted.

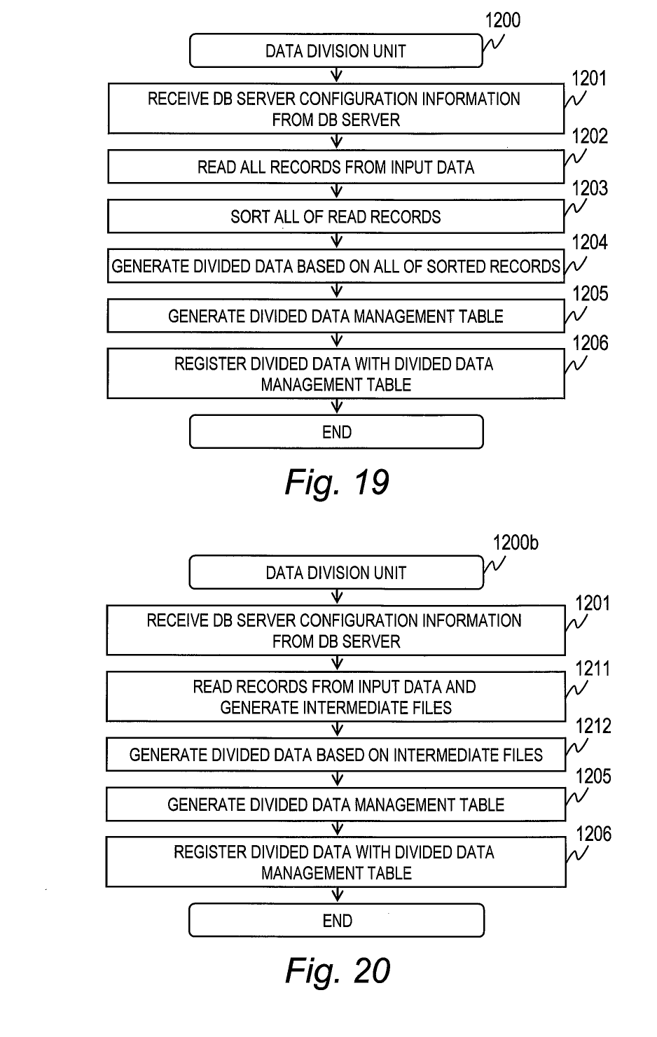

FIG. 19 is a flowchart of first control logic of the data division unit 1200 according to the second embodiment of the present invention. First, the data division unit 1200 receives the DB server configuration information 200 from an arbitrary DB server 30 (Step 1201). Next, the data division unit 1200 reads all records from the input data 120 (Step 1202), and sorts all of the read records (Step 1203).

In case where sorting all of the read records in Step 1203, the DB server names 201 of entries of the managed record identification information 202 including key values of records are used as the first sort key. The key values of records are used as the second sort key. In this way, the sorting is performed such that record groups that are output to the database 100 by the same DB server 30 are arranged in succession. Instead of sorting the records, pointers to the records may be sorted.

Next, the data division unit 1200 divides all of the sorted records into a plurality of record sets, and outputs the plurality of record sets thus generated as different pieces of divided data 130 (Step 1204).

More specifically, in Step 1204, all of the sorted records are divided into a plurality of record sets in order of arrangement thereof in increments of a pre-designated maximum number of records in divided data 130. It should be noted that, in case where the value of the first sort key of a predetermined record differs from the value of the first sort key of an immediately previous record, the predetermined record and the immediately previous record are divided into different record sets, even if the number of records falls below the maximum number of records in divided data 130. This makes it possible to prevent co-existence of records with different first sort key values (that is to say, records that are output to the database 100 by different DB servers 30) in the same divided data 130. Note that it is preferable to perform the division such that records with the same second sort key value are included in the same divided data 130.

Next, the data division unit 1200 generates the divided data management table 500 together with entries that are equal in number to the pieces of divided data 130 (Step 1205). The data division unit 1200 then registers information related to the pieces of divided data 130 generated in Step 1204 with the entries generated in Step 1205 (Step 1206).

In Step 1206, the names of the generated pieces of divided data 130 (or sequence numbers for uniquely identifying the generated pieces of divided data 130) are set to the divided data identifiers 501. The DB server names 201 of entries of the managed record identification information 202 including key values of records included in the generated pieces of divided data 130 are set to the DB server names 503. The numbers of records included in the generated pieces of divided data 130 are set to the numbers of records 504. A default value “UNEXECUTED” is set to the execution states 505. Nothing is set to the job execution server names 506.

In Step 1206, the data division unit 1200 may output the divided data identifiers 501, the DB server names 503 and the numbers of records 504 to a file instead of registering information related to the pieces of divided data 130 with the divided data management table 500. In this case, prior to Step 1110 (see FIG. 10), the job scheduling unit 1100 reads the divided data identifiers 501, the DB server names 503 and the numbers of records 504 from the output file, adds new entries to the divided data management table 500, and registers the read pieces of information therewith.

Through the above-described first control logic, the data division unit 1200 divides input data 120 (record group) into a plurality of pieces of divided data 130 (divided record groups), and registers attribute information of each piece of divided data 130 with the divided data management table 500. Especially in Steps 1203 and 1204, the data division unit 1200 refers to the DB server configuration information 200 and the key values of each record in the input data 120, and generates the plurality of pieces of divided data 130 by combining records that fall within the same key value range (records managed by the same DB server 30) out of the records included in the input data 120. This makes it possible to prevent co-existence of records managed by different DB servers 30 in the same divided data 130. That is to say, the input data 120 is divided such that all of records to be output, which are obtained as a result of processing records in a piece of divided data 130, are output to the database 100 managed by the same DB server 30.

FIG. 20 is a flowchart of second control logic of the data division unit 1200 according to the second embodiment of the present invention. Below, constituent elements that are similar to those illustrated in FIG. 19 are assigned the same reference signs thereas, and descriptions that have already been given above are omitted as appropriate.

As with the above-described first control logic (see FIG. 19), the data division unit 1200 first receives the DB server configuration information 200 from an arbitrary DB server 30 (Step 1201).

Next, the data division unit 1200 reads records from the input data 120 in order, and based on the read records, generates and outputs an intermediate file per record key value (or key value range corresponding to a pre-designated size) (Step 1211).

In Step 1211, an intermediate file is generated per key value range under the assumption that a key value range is a subset of key value ranges shown under the managed record identification information 202. This makes it possible to prevent keys with different DB server names 201 from being included in the same key value range.

Thereafter, the data division unit 1200 generates divided data 130 by combining a plurality of intermediate files generated in Step 1211 (Step 1212). More specifically, with reference to the managed record identification information 202 that includes key values of records in intermediate files, a group of intermediate files including records that belong to the same entry of the managed record identification information 202 (that is to say, records that are output to the database 100 by the same DB server 30) is combined until the total number of records included in the group of intermediate files hits the pre-designated maximum number of records in divided data 130.

The subsequent processes of Steps 1205 and 1206 are similar to those in the above-described first control logic (see FIG. 19), and therefore a description thereof is omitted.

Through the above-described second control logic, the data division unit 1200 can divide input data 120 into a plurality of pieces of divided data 130 via intermediate files and register attribute information of each piece of divided data 130 with the divided data management table 500 without executing the sort processing of the first control logic.

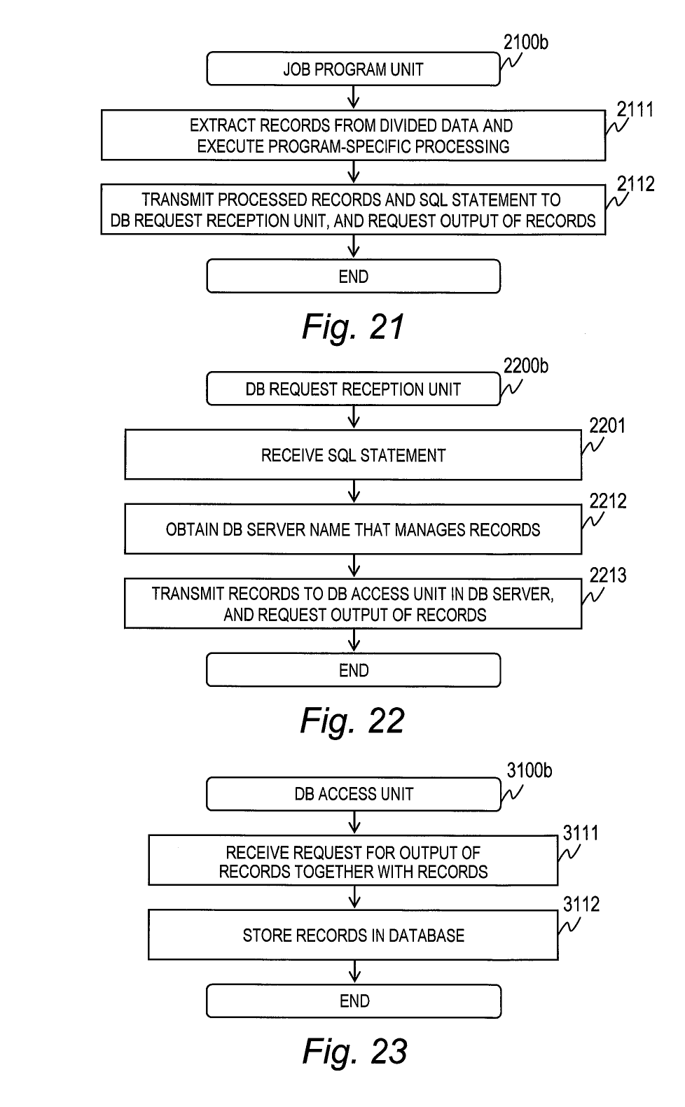

FIG. 21 is a flowchart of control logic of the job program unit 2100b according to the second embodiment of the present invention.

First, the job program unit 2100b extracts records from divided data 130 and executes program-specific processing (Step 2111). This program-specific processing is, for example, processing for checking duplication of the extracted records and modifying the extracted records.

Next, the job program unit 2100b transmits, to the DB request reception unit 2200b, the records to which the program-specific processing was applied in Step 2111, the INSERT statement in SQL, and a request for the output of these records to the database 100 (Step 2112).

Through the above-described processing, the job program unit 2100b extracts records from divided data 130, executes program-specific processing, and transmits records obtained as a result of the processing, the INSERT statement in SQL, and the like to the DB request reception unit 2200b.

FIG. 22 is a flowchart of control logic of the DB request reception unit 2200b according to the second embodiment of the present invention.

As with the first embodiment, the DB request reception unit 2200b first receives the SQL statement (and the records to which the program-specific processing was applied by the job program unit 2100b) from the job program unit 2100b (Step 2201). Next, the DB request reception unit 2200b compares keys of the records received in Step 2201 with the pieces of managed record identification information 202 in the DB server configuration information 200, and obtains a DB server name 201 corresponding to a piece of managed record identification information 202 including the keys of the received records (Step 2212).

The DB request reception unit 2200b then transmits the records to the DB access unit 3100 in the DB server 30 with the DB server name 201 obtained in Step 2212, and requests that DB access unit 3100 to output the records to the database 100 (Step 2213).

Through the above-described processing, the DB request reception unit 2200b refers to the DB server configuration information 200, selects a DB server 30 that manages records obtained as a result of processing executed by the job program unit 2100b, and transmits a request for the output of the records to the database 100 to the DB access unit 3100 in the selected DB server 30.

FIG. 23 is a flowchart of control logic of the DB access unit 3100b according to the second embodiment of the present invention.

First, the DB access unit 3100b receives a request for the output of records (including information of the records) from the DB request reception unit 2200b (Step 3111). Next, the DB access unit 3100 outputs the records received in Step 3111 to the database 100 (Step 3112).

Through the above-described processing, the DB access unit 3100 outputs records obtained as a result of processing executed by the job program unit 2100b to the database 100.

As described above, in parallel distributed processing of jobs that include the output to the database 100, the computer system 1 of the second embodiment of the present invention can prevent contention over access to a DB server 30 that outputs data to the database 100 even if the relationships between the DB servers 30 and the job execution servers 20 are not fixed or if the number of the DB servers 30 and the number of the job execution servers 20 are not equal.

Furthermore, the number of records processed by each job execution server 20 can be appropriately adjusted, and the number of processed records can be balanced among the job execution servers 20. As a result, the loads on the job execution servers 20 and the DB servers 30 can be balanced, thus enabling high-speed execution of jobs.

While the present invention has been described in detail and pictorially in the accompanying drawings, the present invention is not limited to such detail but covers various obvious modifications and equivalent arrangements, which fall within the purview of the appended claims.

### INDUSTRIAL APPLICABILITY

The present invention relates to a computer system and is useful especially for a computer system with batch jobs that include the input/output to a database.

What is claimed is:

1. A computer system comprising:
one or more database servers that execute processing for input/ output records to databases;
one or more job execution servers that execute jobs including the input/output processing; and
a scheduling server that schedules the jobs executed by the one or more job execution servers, wherein
the one or more database servers, the one or more job execution servers and the scheduling server each includes a processor that executes a program and a memory that stores the program executed by the processor,
each of the one or more database server divides a range of key values included in records stored in a database managed by the database server into a plurality of sections, and obtains distribution information of records in each divided section, and
the scheduling server
holds database server configuration information that shows ranges of key values included in records stored in the database managed by the one or more database servers,
generates a plurality of divided ranges by combining a plurality of sections corresponding to the same range of key values based on the obtained distribution information of records and the database server configuration information held in the scheduling server, and
generates a record acquisition range parameter that shows, for each divided range generated, records in the divided range as records to be acquired.

2. The computer system according to claim 1, wherein
the scheduling server outputs management information that shows a corresponding relationship between the generated record acquisition range parameter and a database server that is capable of executing processing for input/output records designated by the generated record acquisition range parameter.

3. The computer system according to claim 2, wherein
the management information further shows whether the database server is currently executing the processing for input/output the designated records, and
in case where there is a database server that is currently executing processing for input/output records designated by a predetermined record acquisition range parameter, the scheduling server restricts the currently executing database server from executing a job that includes processing for input/output other records.

4. The computer system according to claim 1, wherein
the scheduling server transmits the generated record acquisition range parameter to a job execution server that executes a job including processing for input/output records designated by the generated record acquisition range parameter, and
the job execution server, when receiving the transmitted record acquisition range parameter, requests a database server that executes the processing for input/output the records designated by the received record acquisition range parameter to acquire the designated records.

5. The computer system according to claim 1, wherein
each of the one or more database server divides a range of key values included in records stored in a database managed by the database server into a plurality of sections in such a manner that the number of the divided sections is larger than the number of jobs executed by the one or more job execution servers.

6. The computer system according to claim 1, wherein
the scheduling server combines a plurality of sections corresponding to the same range of key values in such a manner that the number of records in each of the divided range generated by the combination is smaller than a predetermined number.

7. A computer system comprising:
one or more database servers that execute processing for input/output records to a database;
one or more job execution servers that execute jobs including the input/output processing; and
a scheduling server that schedules the jobs executed by the one or more job execution servers, wherein
the one or more database servers, the one or more job execution servers and the scheduling server each includes a processor that executes a program and a memory that stores the program executed by the processor, and
the scheduling server
holds database server configuration information that shows ranges of key values included in records stored in the database managed by the one or more database servers, and
in case where storing a predetermined record group in the database managed by the one or more database servers, generates a plurality of divided record groups by combining records corresponding to the same range of key values out of records included in the predetermined record group based on the database server configuration information held in the scheduling server.

8. The computer system according to claim 7, wherein
the scheduling server outputs management information that shows a corresponding relationship between the generated divided record groups and a database server that is capable of executing processing for input/output records included in the divided record groups.

9. The computer system according to claim 8, wherein
the management information further shows whether the database server is currently executing the processing for input/output the records included in the divided record groups, and
in case where there is a database server that is currently executing processing for input/output records included in a predetermined divided record group, the scheduling server restricts the currently executing database server from executing a job that includes processing for input/output records included in other divided record groups.

10. The computer system according to claim 7, wherein
the scheduling server transmits the generated divided record groups to a job execution server that executes a job including processing for input/output records included in the generated divided record groups, and
the job execution server, when receiving the transmitted divided record groups, requests a database server that executes the processing for input/output the records included in the received divided record groups to store the records included in the received divided record groups in case where the job execution server receives the transmitted divided record groups.

11. The computer system according to claim 7, wherein
the scheduling server combines records corresponding to the same range of key values out of records included in the predetermined record group in such a manner that the number of records in the divided record groups generated by the combination is smaller than a predetermined number.

12. A parallel distributed processing method preformed in a computer system including one or more database servers that execute processing for input/output records to the database, one or more job execution servers that execute jobs including the input/output processing, and a scheduling server that schedules the jobs executed by the one or more job execution servers, the one or more database servers, the one or more job execution servers and the scheduling server each including a processor that executes a programs and a memory that stores the program executed by the processor, the scheduling server holding, in the memory, database server configuration information that shows ranges of key values included in records stored in the database managed by the one or more database servers,
the method including steps of:
dividing, by each of the database server, a range of key values included in records stored in a database managed by the database server into a plurality of sections, and obtaining distribution information of records in each divided section, and
generating, by the scheduling server, a plurality of divided ranges by combining a plurality of sections corresponding to the same range of key values based on the obtained distribution information of records and the database server configuration information held in the scheduling server, and generating a record acquisition range parameter that shows, for each divided range generated, records in the divided range as records to be acquired.
